(19) United States
(12) Patent Application Publication
(10) Pub. No.: US 2017/0148310 A1
(43) Pub. Date: May 25, 2017

(54) DETECTION OF CODED LIGHT

(71) Applicant: PHILIPS LIGHTING HOLDING B.V., Eindhoven (NL)

(72) Inventors: FREDERIK JAN DE BRUIJN, EINDHOVEN (NL); GERARDUS CORNELIS PETRUS LOKHOFF, EINDHOVEN (NL)

(21) Appl. No.: 15/310,124

(22) PCT Filed: Apr. 29, 2015
(86) PCT No.: PCT/EP2015/059263

§ 371 Date: Nov. 10, 2016

(30) Foreign Application Priority Data
May 12, 2014 (EP) 14167832.6

(51) Int. Cl. G08C 23/04; H04B 10/556; H04N 5/225; H04B 10/116

(52) U.S. Cl. CPC G08C 23/04; H04B 10/116; H04B 10/5563; H04N 5/2258

(57) ABSTRACT

Apparatus for controlling one or more light sources to emit coded light which is modulated to embed a signal. The apparatus comprises: an interface for receiving information relating to two or more exposure times of one or more cameras on one or more devices, the one or more cameras being operable to detect the coded light based on the modulation; and a controller configured to select at least one property of the modulation, based on the information, such that the modulation is detectable at each of said two or more exposure times.

### TECHNICAL FIELD

The present disclosure relates to the detection of coded light in situations where the exposure time of a detecting camera causes frequency blind spots in the acquisition process, for instance where the coded light is detected by a typical camera of a portable electronic device such as a smartphone or a tablet computer.

### BACKGROUND

Coded light refers to techniques whereby a signal is embedded in the visible light emitted by a luminaire. The light thus comprises both a visible illumination contribution for illuminating a target environment such as room (typically the primary purpose of the light), and an embedded signal for providing information into the environment. To do this, the light is modulated at a certain modulation frequency or frequencies.

In some of the simplest cases, the signal may comprise a single waveform or even a single tone modulated into the light from a given luminaire. The light emitted by each of a plurality of luminaires may be modulated with a different respective modulation frequency that is unique amongst those luminaires, and the modulation frequency can then serve as an identifier of the luminaire or its light. For example this can be used in a commissioning phase to identify the contribution from each luminaire, or during operation can be used to identify a luminaire in order to control it. In another example, the identification can be used for navigation or other location-based functionality, by mapping the identifier to a known location of a luminaire or information associated with the location.

In other cases, a signal comprising more complex data may be embedded in the light. For example using frequency keying, a given luminaire is operable to emit on two (or more) different modulation frequencies and to transmit data bits (or more generally symbols) by switching between the different modulation frequencies. If there are multiple such luminaires emitting in the same environment, each may be arranged to use a different respective plurality of frequencies to perform its respective keying.

Coded light has a number of applications. For example, each luminaire may emit an identifier or other information to be detected by the camera on a mobile device such as a smartphone or tablet, allowing that device to control the luminaire based on the detected identifier or information (via a suitable back-channel, e.g. RF).

WO2012/127439 discloses a technique whereby coded light can be detected using an everyday “rolling shutter” type camera, as is often integrated into a mobile device like a mobile phone or tablet. In a rolling-shutter camera, the camera's image capture element is divided into a plurality of lines (typically horizontal lines, i.e. rows (of pixels)) which are exposed in sequence line-by-line. That is, to capture a given frame, first one line is exposed to the light in the target environment, then the next line in the sequence is exposed at a slightly later time, and so forth. Typically the sequence “rolls” in order across the frame, e.g. in rows top to bottom, hence the name “rolling shutter”. When used to capture coded light, this means different lines within a frame capture the light at different times and therefore, if the line rate is high enough relative to the modulation frequency, at different phases of the modulation waveform. Thus the modulation in the light can be detected.

The exposure time of a camera is known to cause selective frequency suppression which hampers the detection of coded light with a camera. I.e. for any camera there are certain coded light modulation frequencies which are “invisible”, or at least difficult to detect. Specifically, the certain frequencies are those at an integer multiple of 1/Tₑₓₚ where Tₑₓₚ is the exposure time. In the case of a rolling shutter camera, the exposure time is the line exposure time, i.e. the time for which each individual line is exposed. In a global shutter camera (where the whole frame is exposed at once), the exposure time is the frame exposure time, i.e. the time for which each whole frame is exposed. This phenomenon is explored for example in WO2013/108166 and WO2013/108767.

Thus if a camera is used as detector for coded light, the exposure time of that camera causes blind spots in the frequency spectrum of the camera transfer function. Effectively the camera may not be able to receive all possible modulation frequencies that may be sent out by a coded light source or sources.

In an existing lighting system, the system is capable of controlling the pulse-width modulation (PWM) frequencies of each lamp in a system. This allows a different PWM frequency to be assigned to each lamp in the system. To avoid suppression of one or more frequencies during detection, the frequencies are chosen on the basis of the momentary exposure time of the camera.

### SUMMARY

The existing frequency assignment is based on the exposure time of a single camera. In the near future, the inventors foresee that not just one, but multiple different exposure values may need to be satisfied by transmitted coded light signals, e.g. the exposure times of different cameras on different devices which may be present in the environment. For instance concurrent use of coded light based control may be desired by more than one user, such that the transmitted coded light frequencies may need to satisfy detection under at least two different exposure times. The present disclosure provides for negotiation between camera and lighting system to arrive at coded light signals that do not suffer from the suppression due to the momentary exposure time of the detecting camera in the presence of multiple exposure times, e.g. due to multiple detecting cameras that each have a different exposure time.

According to one aspect disclosed herein, there is provided an apparatus for controlling one or more light sources to emit coded light modulated with at least one modulation frequency, where one or more cameras are operable to detect the coded light based on the modulation. The apparatus comprises an interface for receiving information relating to two or more exposure times of one or more cameras on one or more devices. For instance this information may comprise an indication of the exposure time itself, an indication of one or more parameters affecting the exposure time (e.g. an exposure index or “ISO” setting, an exposure value setting, or a region-of-interest setting), or an indication of one or more corresponding frequency blind spots to be avoided. The apparatus further comprises a controller configured to select the at least one modulation frequency, based on said information, to avoid frequency blind spots in said detection caused by each of said two or more exposure times.

In embodiments there are multiple cameras, and the two or more exposure times comprise exposure times of different ones of the cameras. In this case the controller is being configured to select the at least one modulation frequency to avoid frequency blind spots caused by each of the exposure times of the different cameras.

In embodiments there are multiple devices in the form of a plurality of user terminals, and the different cameras comprising cameras on different ones of the user terminals. In this case the controller is configured to select the at least one modulation frequency to avoid frequency blind spots caused by the exposure times of the cameras on each of the different user terminals.

Alternatively or additionally, the different cameras may comprise cameras on a same one of the one or more user terminals; and/or the different exposure times may even comprise different exposure times used by a same one of said one or more cameras at different times.

In further embodiments, there are also a plurality of modulation frequencies. These may comprise multiple modulation frequencies used by the same light sources, and/or modulation frequencies used by different the light sources. In such cases, the controller may be configured to select the modulation frequencies to be distinct from one another and to each avoid the frequency blind spots caused by each of the two or more exposure times.

In embodiments, the controller is configured to arbitrate as to which devices' blind-spot requirements are taken into account in case of multiple competing devices, and/or to determine an optimal modulation frequency given the different requirements of the devices.

In embodiments, the controller may be configured to perform a negotiation comprising: determining whether a value can be selected for the modulation frequency which avoids the frequency blind spots of each of the cameras on the different devices; if so, selecting the determined value for the modulation frequency; and if not, selecting a first value for the modulation frequency detectable by at least a first of the devices, requiring at least a second of the devices unable to detect the first value to wait until detection by the first device has finished, and then changing the modulation frequency to a second value detectable by the second device.

In embodiments, the one or more light sources may comprise a plurality of lights sources, the plurality of light sources comprising a sub-group corresponding to a sub-sets of the devices; and the controller may be configured to restrict the determination of modulation frequency for the sub-group of light sources to determining at least one frequency detectable by the corresponding sub-set of devices.

In embodiments, the controller may be configured to select the modulation frequency with: (i) a signal resulting from the detection that exceeds a disturbance threshold for each of the exposure times; (ii) where the one or more cameras are a plurality of cameras, greater than a threshold difference in an apparent spatial frequency of the modulation as appearing over an image capture element of the different cameras; and/or (iii) where the one or more cameras comprise a plurality of cameras, greater than a threshold difference in apparent temporal frequency of the modulation as captured by the different cameras.

In embodiments, the controller may be configured to select the modulation frequency to be: not an integer multiple of a frame rate of the one or more cameras, and/or greater than a line rate of the camera with the highest line rate. The controller may be implemented on a bridge connecting with the devices via a remote interface, e.g. a wireless interface such as Wi-Fi, Zigbee or other short-range RF wireless access technology. The bridge is thus able to gather the information on the exposure times from the respective devices via this remote interface, e.g. wirelessly. The controller may also control the luminaires via a wireless interface such as Wi-Fi, Zigbee or other short-range RF technology.

For instance, there may be provided a lighting system comprising at least one controllable light source and a bridge arranged to relay commands to the controllable light source(s) from at least two portable electronic devices. In this case the bridge may be configured to receive respective current exposure times from the electronic devices; and to allocate to the light source, or to each of the light sources, a locally-unique modulation frequency which can be detected by both or all of the portable electronic devices at their respective current exposure times.

In an alternative arrangement, the controller may be implemented on one of the devices. In this case the device in question receives the information on the respective exposure times from the other device or devices (e.g. wirelessly) and performs the negotiation itself, communicating the result to the relevant light source or sources (e.g. again wirelessly).

In yet further embodiments, it is not necessarily a modulation frequency that is adapted to accommodate the two or more different exposure times, but some other property (or properties) of the modulation. E.g. the adapted modulation property or properties may comprise: a packet length of the packets, an inter-packet idle period between the packets, a ratio between the packet length and the inter-packet idle period, a total length of the packet length and inter-packet idle period, and/or a repetition rate of a message formed from the packets.

According to another aspect disclosed herein, there is provided a corresponding computer program product embodied on a computer-readable storage medium and configured as when executed to perform the operations of the controller.

### BRIEF DESCRIPTION OF THE DRAWINGS

To assist the understanding of the present disclosure and to show how embodiments may be put into effect, reference is made by way of example to the accompanying drawings in which:

FIG. 1 schematically illustrates a space comprising a lighting system and camera,

FIG. 2 is a schematic block diagram of a device with camera for receiving coded light,

FIG. 3 schematically illustrates an image capture element of a rolling-shutter camera,

FIG. 4 schematically illustrates the capture of modulated light by rolling shutter,

FIG. 5 is an example timing diagram of a rolling-shutter capture process,

FIG. 6 shows an example transfer function in the time domain,

FIG. 7 shows an example transfer function in the frequency domain,

FIG. 8 is a schematic block diagram of a system for negotiating modulation frequency,

FIG. 8a schematically illustrates a message format,

FIG. 9 shows an example power spectrum illustrating frequency selection given two different exposure times in the presence of noise,

FIG. 10 depicts a spatiotemporal frequency domain with an example of two frequencies and associated detection-filter characteristics,

FIG. 11 depicts a spatiotemporal frequency domain with an example of a relatively poor choice of a third frequency on the basis of spatial-frequency detection selectivity,

FIG. 12 depicts a spatiotemporal frequency domain with an example of a relatively poor choice of a third frequency on the basis of apparent temporal-frequency detection selectivity, and

FIG. 13 depicts a spatiotemporal frequency domain with an example of a relatively good choice of a third frequency providing both sufficient spatial as well as temporal frequency detection selectivity.

### DETAILED DESCRIPTION OF EMBODIMENTS

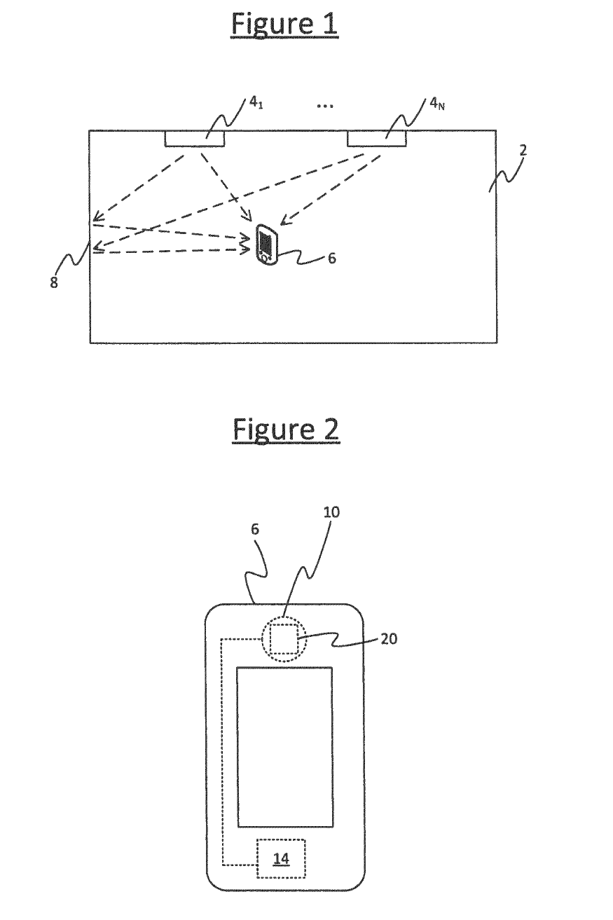

FIG. 1 shows an example environment 2 in which embodiments disclosed herein may be deployed. For instance the environment may comprise one or more rooms and/or corridors of an office, home, school, hospital, museum or other indoor space; or an outdoor space such as a park, street, stadium or such like; or another type of space such as a gazebo or the interior of a vehicle. The environment 2 is installed with a lighting system comprising one or more lighting devices 4 in the form of one or more luminaires. Two luminaires 4i and 4ii are shown for illustrative purposes, but it will be appreciated that other numbers may be present. The luminaires may be implemented under central control or as separate, stand-alone units. Also present in the environment 2 is a user terminal 6, preferably a mobile device such as a smart phone or tablet.

Each luminaire 4 comprises a lighting element such as an LED, array of LEDs or fluorescent tube for emitting light. The light emitted by the lighting element of each of the one or more luminaires is modulated with a coded light component at a modulation frequency. For example the modulation may take the form of a sinusoid, rectangular wave or other waveform. In the case of a sinusoid, the modulation comprises a single tone in the frequency domain. In the case of another waveform like a rectangular wave, the modulation comprises a fundamental and a series of harmonics in the frequency domain. Typically modulation frequency refers to the single or fundamental frequency of the modulation, i.e. the frequency of the period over which the waveform repeats.

When using lighting elements or luminaires for emitting coded light the lighting elements effectively have a dual purpose; i.e. they have a primary illumination function and a secondary communication function. As a result generally the modulation and data encoding are chosen such that the above modulation is preferably invisible to the unaided eye, but can be detected using dedicated detectors, or other detectors such as a rolling shutter camera.

As modern luminaires, LED devices in particular, are generally capable of modulating the light output with frequencies well in excess of frequencies perceptible by the human visual system, and the modulation can be adapted to take into account possible data-dependent patterns (e.g. using Manchester coding), coded light can be encoded in a manner that is substantially invisible to the unaided eye.

In embodiments there may be a plurality of luminaires 4i, 4ii in the same environment 2, each configured to embed a different respective coded light component modulated at a respective modulation frequency into the light emitted from the respective lighting element. Alternatively or additionally, a given luminaire 4 may be configured to embed two or more coded light components into the light emitted by that same luminaire's lighting element, each at a different respective modulation frequency, e.g. to enable that luminaire to use frequency keying to embed data. It is also possible that two or more luminaires 4 in the same environment 2 each emit light modulated with two or more respective coded light components all at different respective modulation frequencies. I.e. so a first luminaire 4i may emit a first plurality of coded light components at a plurality of respective modulation frequencies, and a second luminaire 4ii may emit a second, different plurality of coded light components modulated at a second, different plurality of respective modulation frequencies.

FIG. 2 gives a block diagram of the mobile device 6. The device 6 comprises a camera 10 having a two-dimensional image capture element 20, and an image analysis module 14 coupled to the image capture element. The image analysis module 14 is operable to process signals representing images captured by the image capture element and detect coded light components in the light from which the image was captured. The image analysis module 14 may be implemented in the form of code stored on a computer readable storage medium or media and arranged to be executed on a processor comprising one or more processing units. Alternatively it is not excluded that some or all of the image analysis module 14 could be implemented in dedicated hardware circuitry or reconfigurable circuitry such as an FPGA.

The one or more luminaires 4 are configured to emit light into the environment 2 and thereby illuminate at least part of that environment. A user of the mobile device 6 is able to point the camera 10 of the device towards a scene 8 in the environment 2 from which light is reflected. For example the scene could comprise a surface such as a wall and/or other objects. Light emitted by one or more of the luminaire(s) 4 is reflected from the scene onto the two-dimensional image capture element of the camera, which thereby captures a two dimensional image of the scene 8. Alternatively or additionally it is also possible to detect coded light directly from a light source (without reflection via a surface). Hence the mobile device may alternatively be pointed directly at one or more of the luminaire(s) 4.

In particular when such light sources are imaged directly on the ceiling the detection is substantially simplified, in that the pixels/image elements corresponding to the illumination sources and their direct vicinity provide clear modulation patterns.

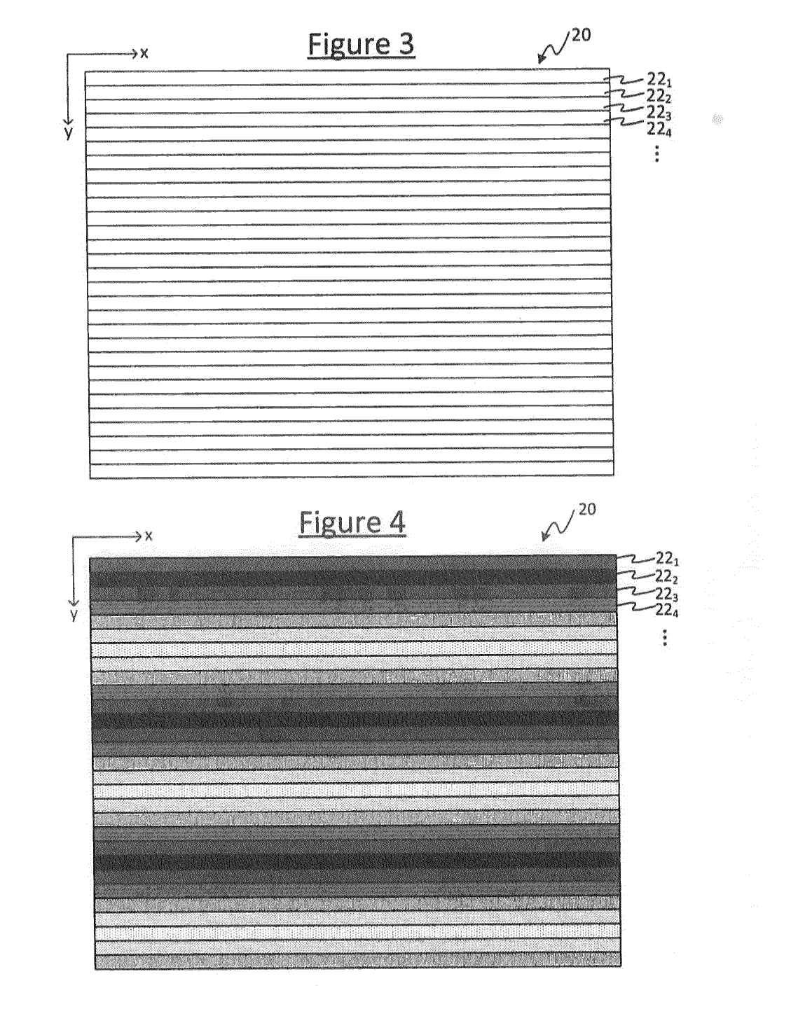

FIG. 3 represents the image capture element 20 of the camera 10. The image capture element 20 comprises an array of pixels for capturing signals representative of light incident on each pixel, e.g. typically a square or rectangular array of square or rectangular pixels. In a rolling-shutter camera, the pixels are arranged into a plurality of lines, e.g. horizontal rows 22. To capture a frame each line is exposed in sequence, each for a successive instance of the camera's exposure time Tₑₓₚ. In this case the exposure time is the duration of the exposure of an individual line. Note also that a sequence in the present disclosure means a temporal sequence, i.e. so the exposure of each line (or more generally portion) starts at a slightly different time. For example first the top row 22₁ begins to be exposed for duration Tₑₓₚ, then at a slightly later time the second row down 22₂ begins to exposed for Tₑₓₚ, then at a slightly later time again the third row down 22₃ begins to be exposed for Tₑₓₚ, and so forth until the bottom row has been exposed. This process is then repeated to expose a sequence of frames.

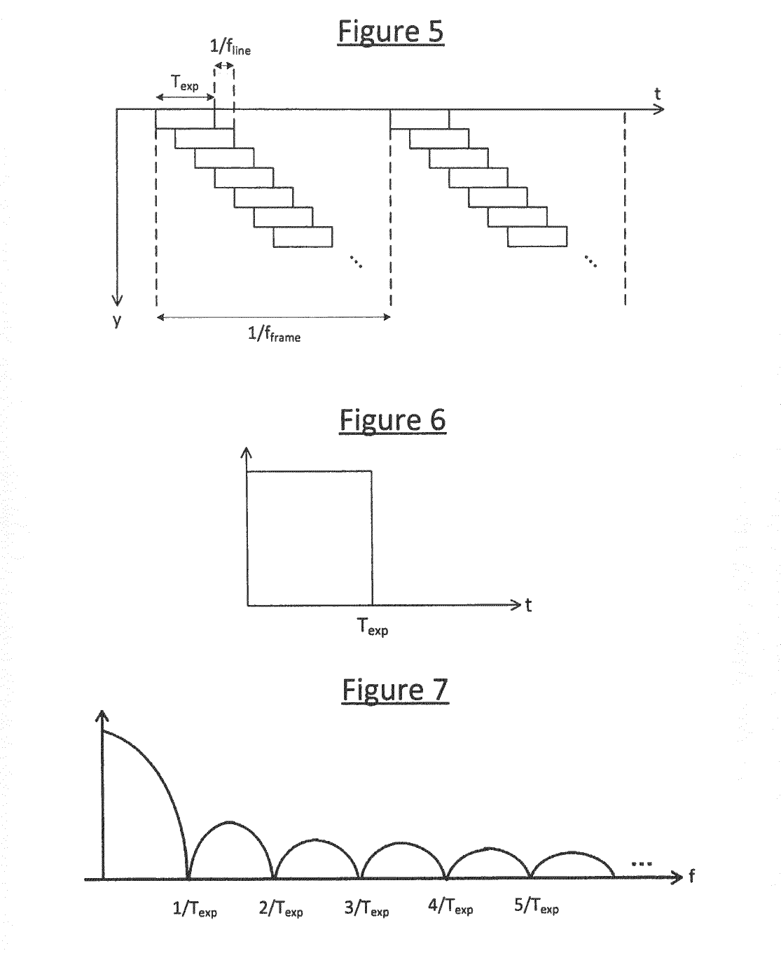

FIG. 5 shows an example of a typical rolling shutter timing diagram during continuous video capture.

In WO2012/127439 for example, it has been described how coded light can be detected using a conventional video camera of this type. The signal detection exploits the rolling shutter image capture, which causes temporal light modulations to translate to spatial intensity variations over successive image rows.

This is illustrated schematically FIG. 4. As each successive line 22 is exposed, it is exposed at a slightly different time and therefore (if the line rate is high enough compared to the modulation frequency) at a slightly different phase of the modulation. Thus each line 22 is exposed to a respective instantaneous level of the modulated light. This results in a pattern of stripes which undulates or cycles with the modulation over a given frame. Based on this principle, the image analysis module 14 is able to detect coded light components modulated into light received by the camera 10.

However, the acquisition process produces a low pass filtering effect on the acquired signal. FIGS. 6 and 7 illustrate the low-pass filtering characteristic of the acquisition process of a rolling shutter camera with an exposure time Tₑₓₚ.

FIG. 6 is a sketch representing the exposure time as a rectangular block function, or rectangular filter, in the time domain. The exposure process can be expressed as a convolution of the modulated light signal with this rectangular function in the time domain. Convolution with a rectangular filter in the time domain is equivalent to a multiplication with a sinc function in the frequency domain. Hence as illustrated by the sketch given in FIG. 7, in the frequency domain this causes the received signal spectrum to be multiplied by a sinc function. The function by which the received signal spectrum is multiple may be referred to as the transfer function, i.e. it describes the proportion of the received signal spectrum that is actually “seen” by the detection process in the detection spectrum.

Thus the exposure time of the camera is a block function in the time domain and a low pass filter (sinc) in the frequency domain. A result of this is that the detection spectrum or transfer function goes to zero at 1/Tₑₓₚ and integer multiples of 1/Tₑₓₚ. Therefore the detection process performed by the image analysis module 14 will experience blind spots in the frequency domain at or around the zeros at 1/Tₑₓₚ, 2/Tₑₓₚ, 3/Tₑₓₚ, etc. If the modulation frequency falls in one of the blind spots, the coded light component will not be detectable. Note that in embodiments, the blind spot need not be considered to occur only at the exact frequencies of these zeros or nodes in the detection spectrum or transfer function, but more generally a blind spot may refer to any range of frequencies around these zeros or nodes in the detection spectrum where the transfer function is so low that a desired coded light component cannot be detected or cannot be reliably detected.

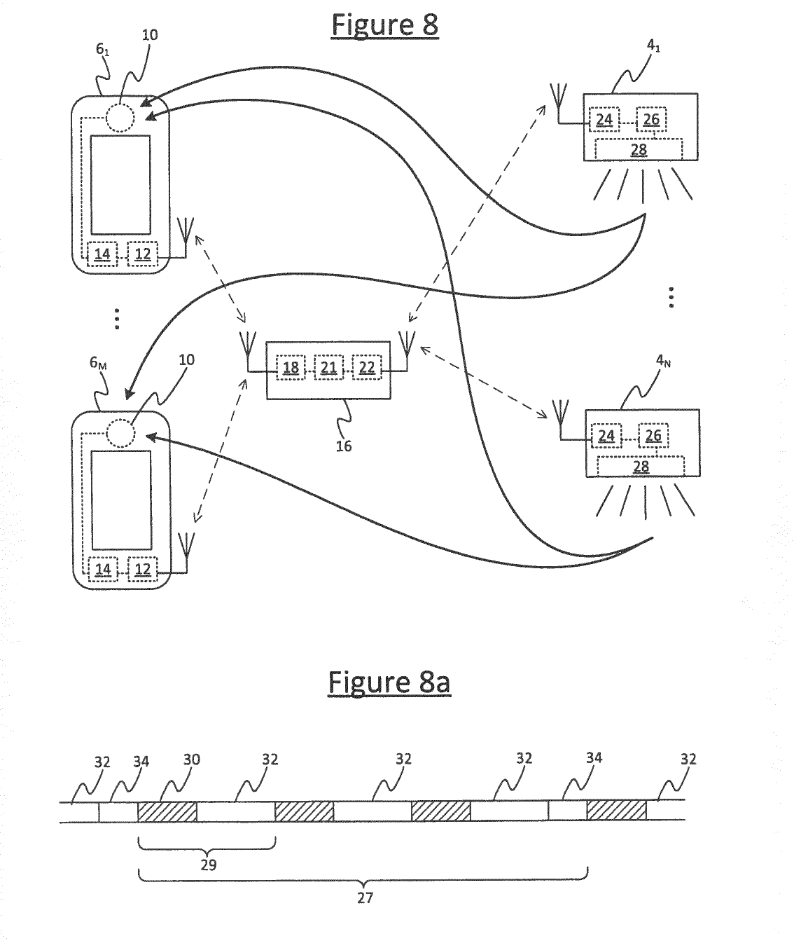

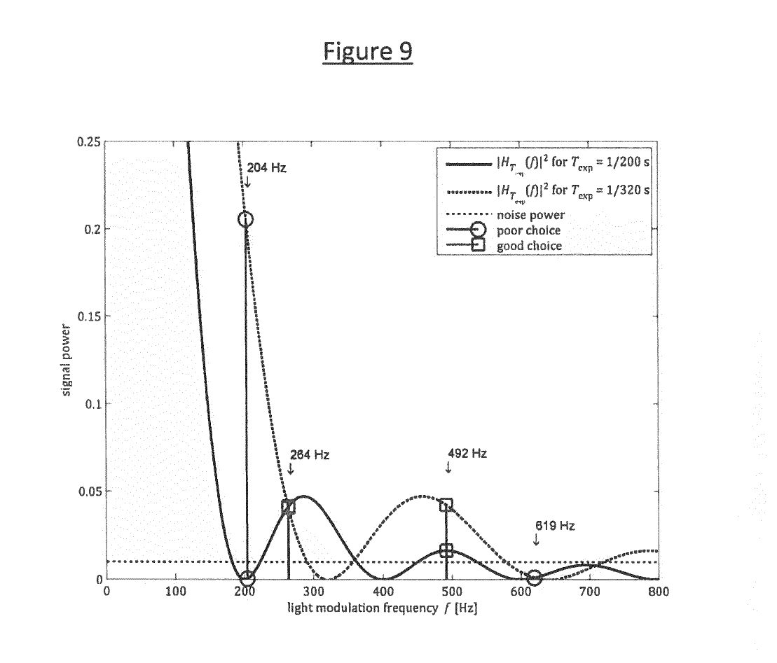

FIG. 8 illustrates a system for negotiating a common modulation frequency given two (or more) exposure times to take into account, in accordance with embodiments of the present disclosure.

The system comprises at least two mobile devices 6₁ . . . 6ₘ each comprising a camera 10 and interface 12 to a network. The system also comprises one or more luminaires 4₁ . . . 4_{N} that each also comprise an interface 24 to a network, as well as a lighting element 28 (e.g. one or more LEDs). In addition the luminaires 4 each comprise a controller 26 coupled to the respective lighting element 28 (via a driver, not shown) configured to modulate the illumination from that lighting element 28 with at least one modulation frequency in order to embed data into its respective illumination. The controller 26 may comprise software stored on a storage medium of the respective luminaire 4 and arranged for execution on a processor of that luminaire 4, e.g. being integrated into the housing or fixture of the luminaire. Alternatively the controller 26 may be partially or wholly implemented in dedicated hardware circuitry, or configurable or reconfigurable hardware such as a PGA or FPGA.

The coded light provides a unidirectional first communication channel from each luminaire 4 to each of the mobile devices 6 in view using the respective camera 10 as receiver. Each mobile device 6 comprises an image analysis module 14 for detecting the data coded into the light from the luminaire(s) 4, as discussed previously.

The network provides a bidirectional second communication channel. The network is preferably wireless and may comprise a bridge 16 that either relays or translates the communicated data. When the bridge relays data within a singular network, then the bridge offers functionality that has a likeness to that of an 802.11 access point. However when the device actually translates data from one protocol to the other, then the functionality much more resembles that of a true bridge.

The network can also be partly wireless and partly wired, e.g. providing a wireless connection with the (mobile) device and a wired connection to one or more luminaires. In the case of wireless connection, each of the mobile devices 6 comprises a wireless interface 12 and the bridge 16 comprises a complementary wireless interface 18 by which each of the mobile devices 6 can connect with the bridge 16. For example these interfaces 12, 18 may be configured to connect with one another via a short-range RF access technology such as Wi-Fi, Zigbee or Bluetooth. Alternatively or additionally, each of the one or more luminaires 4 comprises a wireless interface 24 and the bridge 16 comprises a complementary wireless interface 22 by which each of the luminaires 4 can connect with the bridge 16. For example these interfaces 24, 18 may also be configured to connect with one another via a short-range RF access technology such as Wi-Fi, Zigbee or Bluetooth. Note that in embodiments, the bridge 16 is configured to communicate with the mobile devices 6 using the same wireless technology as it uses to communicate with the luminaires 4, in which case the blocks 18 and 22 may in fact represent the same interface. However, they are labelled separately in FIG. 8 to illustrate that this is not necessarily the case in all possible embodiments.

The wireless connection between the mobile devices 6 and the bridge, and between the bridge and the luminaires, thus forms a network (or part of a network) providing a second communication channel in addition to the first, coded light channel. The network may be a wireless local area network (WLAN) based on a wireless access technology such as Wi-Fi, Zigbee, Bluetooth or other short-range RF technology. This second channel allows communication between the mobile devices 6 and luminaire(s) 4, allowing each of the mobile devices 6 the possibility to control one or more of the luminaires 4, e.g. to dim the luminaires(s) and/or switch them on and off, and/or to control other properties such as the colour. Alternatively or additionally, each of the mobile devices 6 may be able to communicate directly with the one or more luminaires 4 via their respective interfaces 12, 14, e.g. again wirelessly via a technology such as Wi-Fi, Zigbee, Bluetooth or other short-range RF technology, and thus provide the second communication channel that way, again allowing mobile device 6 the possibility to control one or more of the luminaires 4.

In embodiments, the disclosed system also uses the second communication channel to enable concurrent detection of coded light with two or more different cameras 10 that have different exposure times.

A first embodiment uses a common unit in the form of the bridge 16 (e.g. a SmartBridge) where all exposure times are collected and where on the basis of the momentary exposure times an optimal frequency selection is calculated to satisfy all the momentary exposure times.

In this embodiment, the image analysis module 14 on each mobile device 6 is configured with an additional role to inform the bridge 16 about its exposure time and therefore the modulation frequencies which it will be unable to detect. The image analysis module 14 is therefore configured to automatically transmit information related to the exposure time of the respective mobile device 6 to the bridge 16, via the interfaces 12, 18 (e.g. via the wireless connection).

The information related to the exposure time may be an explicit indication of the exposure time itself, e.g. an exposure time setting; or may be another parameter which indirectly affects the exposure time, e.g. an exposure index or “ISO” setting, an exposure value setting (different from the exposure time setting) or a region-of-interest setting. That is, some cameras may not have an explicit exposure time setting that can be controlled by applications, but may nonetheless have one or more other settings which indirectly determine exposure time. One example is a region-of-interest setting allowing a sub-area called the region of interest (ROI) to be defined within the area of the captured image, where there camera also has a feature whereby it automatically adjusts the exposure time based on one or more properties of the ROI (e.g. amount of light in the ROI and/or size of the ROI). Hence in embodiments, one or more settings such as the ROI may be indicative of the exposure time where no explicit exposure setting is allowed.

As another possibility, the information related to the exposure time may comprise an indication of the frequency blind spots corresponding to the exposure time, i.e. the mobile device 6 tells the bridge which frequencies to avoid. Whatever form it takes, preferably this information is transmitted dynamically, e.g. in response whenever the mobile device changes its exposure time, or periodically.

The bridge comprises a controller 21 which is configured to allocate a modulation frequency to each of the one or more luminaires 4 in the system. It gathers the information of the exposure times of the different cameras 10 received from the different respective devices 6, and automatically determines a modulation frequency for one or more of the luminaires 4 that can be detected by all of the cameras 10 of the different devices 6, or at least as many as possible. The controller 21 on the bridge 16 then communicates the relevant frequency to each of these luminaires via the respective interfaces 22, 24, e.g. wirelessly. Preferably the controller 21 is configured to perform this process dynamically, i.e. adapting the modulation frequency in response to the dynamically transmitted exposure time information from the mobile devices 6.

Note that in embodiments, there are a plurality of luminaires 4 and the controller 21 is configured to assign a different respective modulation frequency to each of these luminaires 4. For example, each modulation frequency may be selected to be unique within the environment 2 in question (e.g. within a given room, building or part of a building) and may be mapped to an identifier of the respective luminaire 4. In such cases the controller 21 is configured to select a modulation frequency for each of the luminaires 4 that can be detected by each of the mobile devices 6 given knowledge of their exposure times and the different respective frequency blind spots these correspond to. The relation between light identifier and frequency is also made available to the mobile devices that require coded light detection, e.g. transmitted back on the connection between the interfaces 12, 18 of the bridge 16 and mobile devices 6, e.g. the wireless connection. Thus the image analysis module 14 on each mobile device 6 is able to identify each of the luminaires 4 in the environment.

Further, in some embodiments each of the one or more luminaires may emit light modulated with not just one, but two or more modulation frequencies. For example, if one or more of the luminaires transmits data in the light using frequency shift keying, then each such luminaire transmits with a respective pair or respective plurality of modulation frequencies to represent different symbols. Or in yet further embodiments, it is also possible for given luminaire to emit light with multiple different simultaneous modulation frequencies. In such cases the controller 21 is configured to select a value for each of the multiple modulation frequencies for each of the one or more luminaires 4 that can be detected by each of the mobile devices 6 given knowledge of their exposure times and the different respective frequency blind spots these correspond to.

In a second embodiment, the bridge 20 is not required and instead the momentary exposure time values are shared among all mobile devices 6 that require coded light detection. In this case the controller 21 is implemented by one of the mobile devices 6 which calculates the frequencies that satisfy all momentary exposure times and communicates the frequencies and (if required) associated identifiers to all others of the mobile devices 6 and to the lighting system 6. This variant does not require a bridge 20, or at least does not require the bridge to be involved in the frequency assignment.

In the second embodiment, all other features of the controller 21 discussed above may still apply. For instance the controller 21 is preferably still configured to dynamically adapt the modulation frequency or frequencies its selects to be detectable by the multiple devices 6 in response to changing exposure time information. Further, where there are multiple luminaires 4 with different modulation frequencies and/or multiple modulation frequencies per luminaire 4, the controller 21 is preferably still arranged to select a value for each of these that satisfies the detection of each of the exposure times of the different devices 6 in the system.

Wherever implemented (a bridge 16 or one of the mobile devices 6), the controller 21 may advantageously be configured to arbitrate as to which devices' blind-spot requirements are taken into account in case of multiple competing devices, and/or to determine an optimal modulation frequency given the different requirements of the devices 6. Notably the controller, apart from the constraints presented by the mobile devices, may also need to take into account the capabilities of the lighting elements. In particular when there is substantial diversity between lighting elements used, it may be necessary to also take into account the actual capabilities of such devices within a particular building, within a room or within an area where the mobile devices reside when determining the optimal modulation. However, as the lighting elements generally are not mobile, the constraints as presented by the lighting elements generally are substantially constant. Constraints of the respective lighting elements may therefore be collected during the commissioning phase of the lighting system, or could additionally or alternatively be actively requested from the lighting elements by the controller.

To try to find a modulation frequency that is detectable by all the desired exposure times in the system, or at least as many as possible, most generally this may be performed by assessing the transfer function (as in FIG. 7) for each of the cameras 10 of each of the devices that are to be taken into consideration, e.g. each in the relevant environment 2. The possible modulation frequencies are then those excluding regions around the nulls (1/Tₑₓ, 2/Tₑₓ, 3/Tₑₓ, etc. in FIG. 7)—of each of the cameras 10 of each of the devices 6—where the suppression is such that suitably reliable detection is not possible. I.e. it is not just the exact frequency l/Tₑₓₚ that is excluded, but a window around 1/Tₑₓ, where the transfer function is too low for detection, and similarly for 2/Tₑₓ, etc. The width of this window depends on the application, e.g. the robustness of the detection process, the amount of noise designed for, and/or the desired reliability.

Beyond this, in embodiments it may also be desirable to choose an optimal frequency from amongst those that are not excluded by the blind-spots. For instance, as well as just selecting modulation frequencies that are in themselves detectable by each of the devices 6, where multiple modulation frequencies are to be selected it may also be desirable to select modulation frequencies that have a certain separation between them. That is, it may not be appropriate to just bluntly place the modulation frequencies in the peaks of the transfer functions, as it may also be required to separate the channels sufficiently.

In embodiments, the controller 21 may be configured to determine such an optimal frequency (or frequency) based on:

sufficient signal amplitude for all of the momentary exposure times given the strength of signal disturbances such as noise, e.g. as illustrated in FIG. 9;

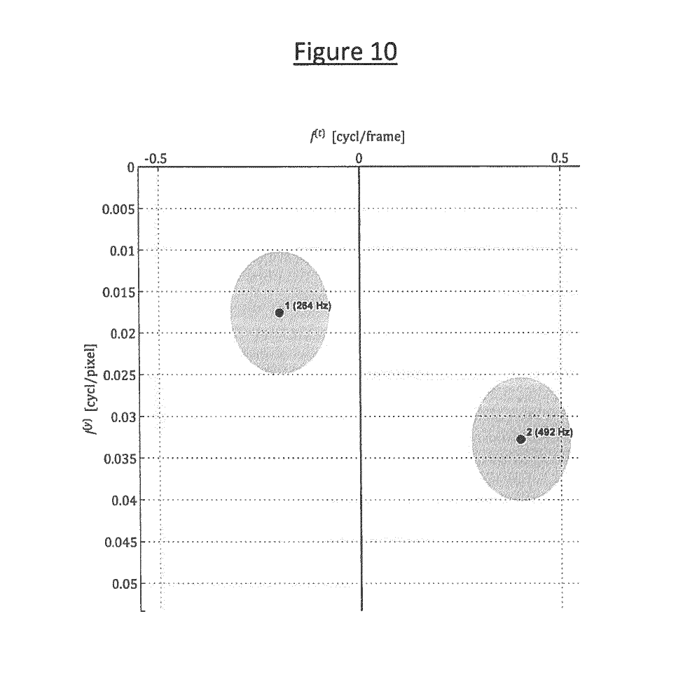

sufficient difference in apparent spatial frequency, e.g. FIG. 10 illustrates a poor choice for an additional third frequency;

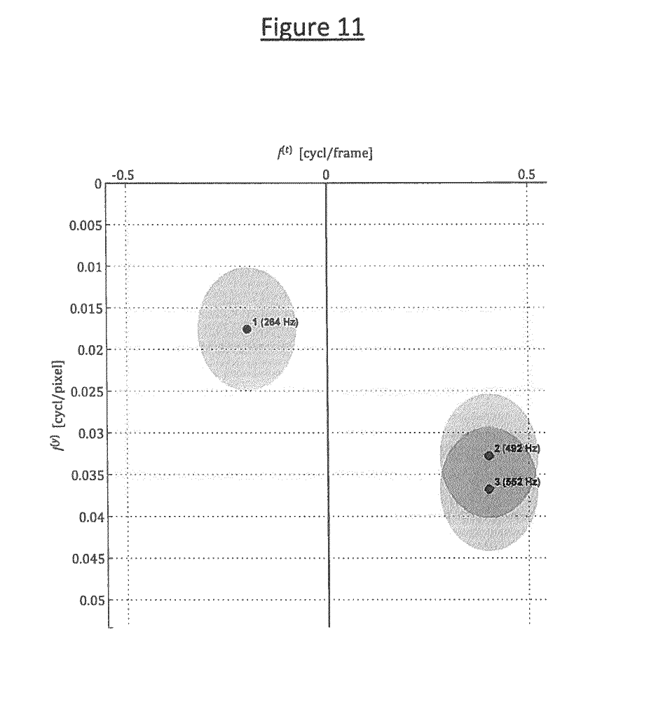

sufficient difference in apparent temporal frequency, e.g. FIG. 11 illustrates a poor choice for an additional third frequency; or

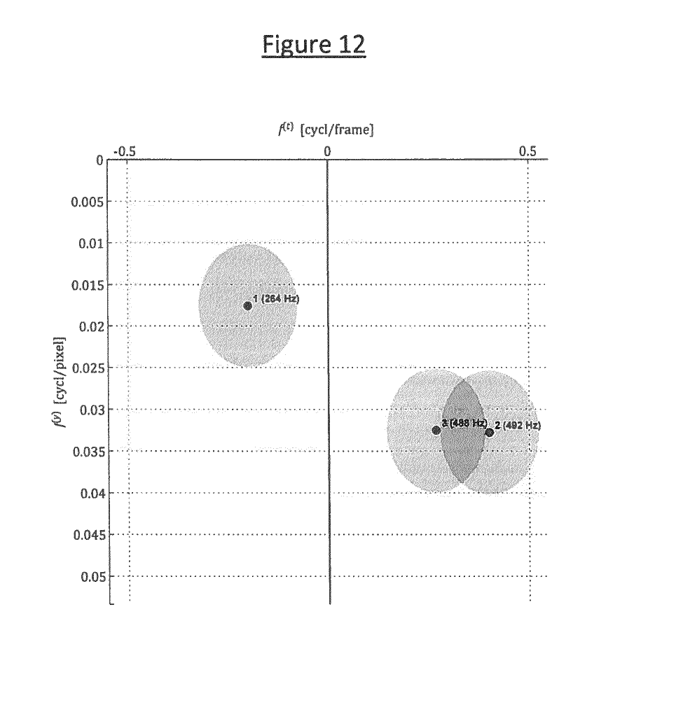

a combination of two or more of the above, e.g. FIG. 12 illustrates a good choice for an additional third frequency.

The sufficient signal amplitude and separation may depend on a number of factors (e.g. coding method, detector algorithm, environmental conditions), as well as the reliability of signal detection desired by the designer for the application in question. The amplitude is that required to achieve signal detection of each component with the desired reliability in the face of noise or other external disturbance. The separation is that required to achieve signal detection of each component given the selectivity of the detector in the spatio-temporal domain. In embodiments the desired values for these may be determined empirically, or alternatively it is not excluded that they may be determined analytically, or using a combination of techniques.

FIG. 9 shows the power spectrum associated with the exposure-related signal suppression H_{Texp} given two different exposure times as well as relatively poor and relatively optimal modulation frequency choices given a level of noise. The choice for a modulation frequency f=619 Hz would lead to a relatively weak intensity modulation for the two cameras having the two respective exposure times. Similarly, a choice for f=204 Hz would only benefit the detection by one of the two cameras. Otherwise a choice for f=264 Hz would result in a relatively high and virtually equal detected signal magnitude for both cameras. Even a choice for f=492 Hz results in a relatively high detected signal magnitude for both cameras, despite difference in detected amplitude between the two cameras.

Hence in embodiments, the controller 21 is configured to select the modulation frequency such that a signal resulting from the detection exceeds a disturbance threshold for each of the exposure times.

FIG. 10 depicts a spatiotemporal frequency domain with the location of two different modulation frequencies as well as an indication of the selectivity of a spatiotemporal detection filter. The spatiotemporal domain shows the apparent spatial and apparent temporal frequency (associated with apparent vertical motion) of a spatial pattern in a sequence of images due to a light modulation with a frequency f [Hz]. I.e. the apparent spatial frequency is the number of cycles per line due to the modulation as appearing in the rolling shutter image capture element 20 of the camera, and the apparent temporal frequency is the number of cycles in the light due to the modulation captured by the image capture element 20 per unit time. The vertical axis depicts the apparent vertical spatial frequency of a spatial pattern due to the light modulation and is denoted here by f^{y} [cycl/pixel] which is linearly related to the light modulation frequency f [Hz] according to f^{y}=f/fₗᵢₙₑ, where fine [Hz] denotes the line rate. As in image processing, the vertical spatial axis is pointing down, the spatial-frequency axis is chosen pointing down as well. The horizontal axis of the spatiotemporal domain depicts the apparent temporal frequency of a spatial pattern due to a light modulation over the sequence of captured images.

The apparent temporal frequency, denoted by f^{t} [cycl/frame], is typically subject to aliasing as light modulation frequencies tend to be chosen much higher than the commonly used frame rates f_{frame} [Hz]. The relation with the light modulation frequency is f t=f f_{frame}, and is plotted in the fundamental frequency interval −½<f^{t}<½ [cycl/frame]. The depicted coordinates are associated with the light modulation frequencies f of 264 and 492 Hz. The disks around each point indicate the frequency selectivity of a spatiotemporal detection filter; the outline of the disk represents the 3 dB contour of the detection filter, the simplest implementation of which is a weighted summation of DFT coefficients after a 2D FFT of a temporal stack of co-located image columns.

FIG. 11 depicts the same spatiotemporal frequency domain as in FIG. 10, but with an additionally chosen third light modulation frequency. The depicted choice for 552 Hz results in a poor detection selectivity on the basis of spatial frequency.

FIG. 12 depicts the same spatiotemporal frequency domain as in FIG. 10, again with an additionally chosen third light modulation frequency. Yet the choice for 488 Hz is poor on the basis of apparent temporal frequency selectivity.

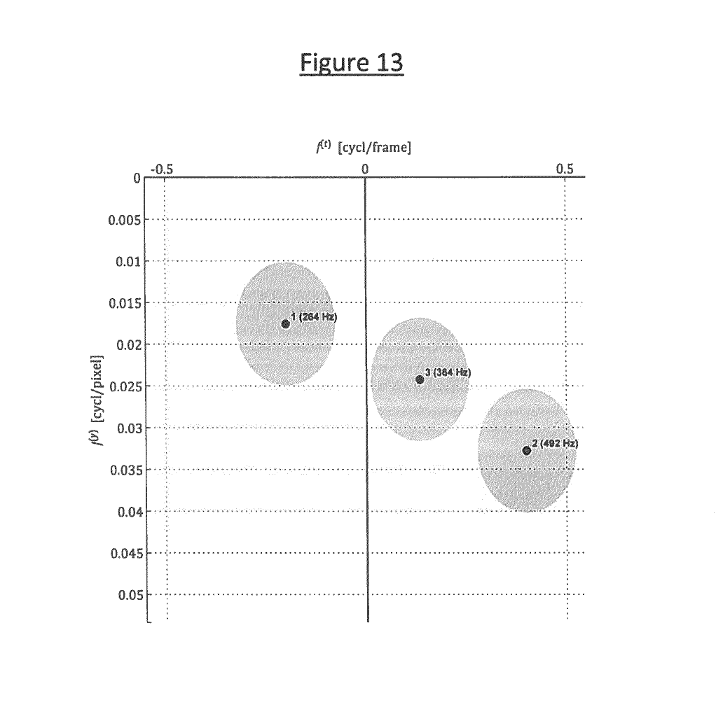

FIG. 13 depicts the same spatiotemporal frequency domain as in FIG. 10, now with an additionally chosen third light modulation frequency of 364 Hz. This choice results in a good detectability of all three frequencies with proper spatiotemporal frequency selectivity given the indicated 3 dB bandwidth of a spatiotemporal detection filter.

Hence in embodiments, the controller 21 is configured to select the modulation frequency such that there is greater than a threshold difference in the apparent spatial frequency of the modulation as appearing over an image capture element 20 of the different cameras, and/or greater than a threshold difference in the apparent temporal frequency of the modulation as captured by the different cameras.

Also, differences in camera characteristics that might require a different frequency set may comprise one or more of the following.

Exposure time (as discussed above)

Frame rate—Different frame rates cause a given light modulation frequency to result in a light pattern that has different apparent temporal frequencies within the captured image sequence. Any light modulation frequency that is an integer multiple of a particular frame rate causes the associated spatial pattern to appear motionless within a captured sequence of images. The apparent rolling motion of a spatial light pattern benefits the separation of an associated modulating signal from the image sequence in the presence of other textured objects in the captured scene (e.g. other static textures on illuminated objects with prominent repetitive patterns).

Line rate—The differences in line rate cause a given light modulation frequency to result in a light pattern that has different spatial frequencies within a captured image. Relatively high line rates result in relatively low-frequency spatial patterns of which a single period may become even larger than the height of the image, leading to poor detection selectivity on the basis of spatial frequency. Thus in the case of multiple cameras with different line rates, the camera with the highest line rate (i.e. the camera currently using the highest line rate) will determine a lower boundary for the choice of light modulation frequencies. For example, such lower boundary can be constituted by the modulation frequency that causes a spatial pattern of which at least one period that fills the entire height of the image frame.

As the number of devices 6 increases, the number of exposures times that may potentially be taken into account increases, and the problem of finding a modulation frequency detectable under each of the different exposure times of the different devices 6 becomes increasingly unlikely to have a satisfactory solution.

Therefore in embodiments the controller 21 is configured with an arbitration protocol as to how to negotiate between two (or more) devices 6 where it is not possible to find a frequency that satisfies all exposure times of both (or all) devices 6 that may wish to detect the coded light in the environment 2 in question. According to this protocol, the controller is configured to:

determine whether a common value can be selected for the modulation frequency which avoids the frequency blind spots of each of the cameras on the different devices (e.g. based on the criteria discussed above);

if so, select the determined value for the modulation frequency; and

if not, select a first value for the modulation frequency detectable by at least a first of the devices. At least a second of the devices, unable to detect the first value, is required to wait until detection by the first device has finished (e.g. the first device has left the environment 2, or has finished receiving the required data). After that, the controller 21 changes the modulation frequency to a second value detectable by the second device (but not the first).

So for example in a system with one or more luminaires 4 with a coded light function and which communicate with a central bridge 16, initially one smart device 6₁ with coded light detector is active and this communicates with the bridge 16. The controller 21 on the bridge allocates a modulation frequency (or frequencies) to the luminaire 4 (or each of the maps 4) that can be detected by the first device 6₁. Alternatively this same functionality could be implemented by a controller 21 on the first device 6₁ or another of the user devices 6.

If a second device 6₂ with a coded light detector then enters the scene, it registers with the controller 21 and provides e.g. its exposure time and/or other characteristics. Possible scenarios are then:

the second device 6₂ detects coded light is already coming from the luminaire(s) 4 and decides to wait until it ends;

the (central) control function 20 declines the second device access as long as the first detecting device 6₁ is not finished;

the control function 20 checks whether or not a frequency set can be generated that supports detection by both devices, and

this is not possible->the second detecting device 6₂ has to wait;

this is possible->both detecting devices 6₁, 6₂ can detect the coded light.

Or for example, if the controller 21 is able to accommodate the exposure times of two devices 6 and then a third enters the environment 2, the third device may be required to wait until one of the first two has left before the controller 21 adapts the modulation frequency (or frequencies) to be detectable by the third device.

In further embodiments, the controller 21 is configured to split up the problem by region, e.g. room-by-room. That is, as mentioned, as the number of devices 6 and therefore possible exposures times increases, the problem of finding a suitable modulation frequency for all the different exposure times of the different devices 6 becomes increasingly unlikely to have a satisfactory solution. Therefore it would be desirable to determine which of the (potentially) detecting devices 6 should in fact be taken into account for the purpose of allocating the modulation frequency (or frequencies) of which luminaires 4.

Hence in embodiments, the plurality of luminaires 4 may be divided up so as to define at least one sub-group of the luminaires, each sub-group corresponding to a sub-set of the mobile devices. For example the luminaires 4 are divided into sub-groups, such as the luminaires in different rooms or regions of a building, and the sub-group of luminaires 4 in a given room or region are considered to be relevant only to the sub-set of the devices 6 within that room and region (e.g. because only that sub-set of devices can detect them, and/or only those devices' users are affected by their illumination). In such situations, the controller 21 may be configured to restrict the determination of modulation frequency for the sub-group of light sources to determining at least one frequency detectable by the corresponding sub-set of devices 6.

For example consider a system with multiple coded light luminaires 4 in different rooms or parts of a room, and one of the detecting devices 6 wants to control the lights. Possible scenarios are then:

if the luminaires 4 have not been grouped according to e.g. room the lights in all rooms will have to go on to enable coded light emissions (and the arbitration discussed above may apply); or

if the luminaires 4 have been grouped according to e.g. room, one has to determine which group to enable detection. This can be achieved manually or e.g. all luminaires in a group could receive a command to emit the same coded light information. Once the group is determined, in a next step individual luminaires can be detected.

It will be appreciated that the above embodiments have been described by way of example only.

For instance, while the above has been described in terms of one camera per device 6, alternatively or additionally it is also possible that different cameras may be included on the same device. In this case the controller 21 may be configured to take into account the exposure times of the different cameras on the same device, at least where such cameras are to detect the coded light, and to select the one or more modulation frequencies to be detectable by each such camera.

Further, it is even possible that the different exposure times are required by a single given camera (e.g. for high-dynamic-range image capture). In this case the controller 21 may be configured to take into account the different exposure times of the same camera on the same device, and to select the one or more modulation frequencies to be detectable by that camera at each of its exposure times.

The disclosed techniques are applicable in a wide range of applications, such as detection of coded light with camera based devices such as smartphones and tablet computers, camera-based coded light detection (e.g. for light installation in the consumer and professional domain), personalized light control, light-based object labelling, and light based indoor navigation.

Further, the applicability of the invention is not limited to avoiding blind spots due to rolling shutter techniques, or to blind spots in any particular filtering effect or detection spectrum. For example, a global shutter could be used if the frame rate was high enough, in which case the exposure time can still have an effect on the frequency response of the detection process. It will be appreciated given the disclosure herein that the use of different exposure times can reduce the risk of modulation going undetected due to frequency blind spots resulting from any side effect or limitation related to the exposure time of any detection device being used to detect the modulated light.

As mentioned, where the modulation takes the form of a non-sinusoidal waveform like a rectangular wave, typically the modulation frequency refers to the fundamental frequency. In the above examples where the blind spots occur at integer multiples of 1/Tₑₓ, then for waveforms like a rectangular wave made up of a fundamental and harmonics an integer multiples of the fundamental, ensuring that the fundamental modulation frequency avoids a blind spot also means the harmonics avoid the blind spots. Nonetheless, generally it is not excluded that the coded light component is considered to be modulated with the frequency of the fundamental and/or any desired harmonic, and avoiding that the modulation frequency corresponds to a blind spot can mean avoiding that the fundamental and/or any desired harmonic (that affects the ability to detect the component) falls in a blind spot.

In yet further variants, it is not necessarily a modulation frequency that is adapted to accommodate the two or more different exposure times, but some other property of the modulation. The above has been described in terms of a coded light signal embedded with a continuous wave (CW) modulation having one or more identifiable modulation frequencies (i.e. a single tone per light source acting as IDs of the light sources), but the disclosed ideas may alternatively apply to packetized modulation formats which may have a number of rates for the transmission of symbols.

The latter refers to a situation where data is encoded into the light in a packetized form. The data may be codes using a scheme such as non return to zero (NRZ), a Manchester code, or a ternary Manchester code (e.g. see WO 2012/052935). In case of packetized transmission, the preferred values for various properties of the message format may depend on the exposure time. Therefore according to embodiments disclosed herein, it may be desirable to adapt one or more such properties in dependence on the information about the two or more cameras' different exposure times.

An example of a message format is shown in FIG. 8a. In embodiments, to ensure the message can be captured even given a small footprint, the coded light signal may be transmitted according to a format whereby the same message 27 is repeated multiple times in succession, and the timing of this is configured relative to the exposure time of the camera or the range of possible exposure times of anticipated cameras—such that the message “rolls” over multiple frames. That is, such that a different part of the message is seen by the camera in each of a plurality of different frames, in a manner that allows the full message to be built up over time as different parts of the message are seen. One potential issue here is therefore the manner in which the message length (duration) Tₘ is chosen relative to the exposure time Tₑₓₚ, such that in reconstruction the rolling shutter camera images another part of the message in every frame (wherein the parts of the message are not necessarily consecutive, and in fact for rolling shutter cameras they will often not be consecutive). According to embodiments disclosed herein, the message timing may be adapted in response to the information on multiple cameras' exposure times Tₑₓₚ

In embodiments, aside from the length (duration) of the message's actual data content (payload) 30, the message length Tₘ (and therefore message repetition rate) may be selected by including an inter-message idle period (IMIP) 34 between repeated instances of the same message. That way, even if the message content alone would result in each frame seeing more-or-less the same part of the message, the inter-message idle period can be used to break this behaviour and instead achieve the “rolling” condition discussed above. In embodiments the controller 21 is configured to adapt the inter-message idle period given feedback of Tₑₓₚ for multiple cameras, such that the message is detectable by each of the cameras at each of the multiple different exposure times.

Another potential issue is inter-symbol interference (ISI), which is a result of the filtering effect of the exposure of each line (effectively a box filter applied in the time domain as each line is exposed). To mitigate this, in embodiments the message format is arranged such that each instance of the message comprises a plurality of individual packets 29 (e.g. at least three) and includes an inter-packet idle period (IPIP) 32 between each packet. In embodiments, the inter-packet idle period follows each packet, with the inter-message idle period (IMIP) 34 tagged on the end after the last packet (there could even be only one packet, with the IPIP 32 and potentially IMIP 34 following).

Inter-symbol interference is then a function of packet length and inter-packet idle period. The more data symbols there are in a row, the more inter-symbol interference (ISI). Therefore it is desirable to keep the packet length small with good sized gaps in between. The idle gaps (no data, e.g. all zeros) between bursts of data helps to mitigate the inter-symbol interference, as does keeping the packet length short. On the other hand, if packets are too short or the IPIP too long, the data rate of the signal suffers. Therefore in embodiments, the controller 21 may be configured to adapt the packet length and/or IPIP (or ratio between them) in response to actual knowledge of multiple cameras' exposure times. One or more of these properties is preferably adapted such that the ISI is not too strong to prevent detection at any of the multiple exposure times, but nonetheless the data rate of the signal is as high as it can be without becoming undetectable due to the ISI.

Another potential issue is inter-packet interference (IPI), which dependents on the inter-packet idle period. The closer the packets, the more inter-packet interference. On the other hand, if the IPIP is too long, again the data rate of the signal suffers. Therefore in embodiments, the controller 21 may be configured to adapt the IPIP in response to knowledge of multiple cameras' exposure times, preferably such that the IPI is not too strong to prevent detection at any of the multiple exposure times, but nonetheless the data rate of the signal is as high as it can be without becoming undetectable due to the IPI. In embodiments, the inter-packet idle period is set to be greater than or equal to the highest exposure time. I.e. the camera with the longest exposure time is the limiting factor. The controller 21 therefore negotiates what is the lowest inter-packet spacing it can use, in order to maximise the capacity of the channel but only to the extent that it doesn't become too short to prevent detection at any of the relevant exposure times.

It will be appreciated that the invention also applies to computer programs, particularly computer programs on or in a carrier, adapted to put the invention into practice. The program may be in the form of a source code, an object code, a code intermediate source and an object code such as in a partially compiled form, or in any other form suitable for use in the implementation of the method according to the invention.

Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

As stipulated above the invention may further be embodied in the form of a computer program product. When provided on a carrier, the carrier of a computer program may be any entity or device capable of carrying the program. For example, the carrier may include a storage medium, such as a ROM, for example, a CD ROM or a semiconductor ROM, or a magnetic recording medium, for example, a hard disk. Alternatively, the carrier may be an integrated circuit in which the program is embedded, the integrated circuit being adapted to perform, or used in the performance of, the relevant method.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. Apparatus for controlling one or more light sources to emit coded light comprising light which is modulated to embed a signal, the apparatus comprising:
an interface for receiving information relating to two or more exposure times of one or more cameras on one or more devices, the one or more cameras being operable to detect the coded light based on detecting the modulation; and
a controller configured to select at least one property of the modulation, based on said information, such that the modulation is detectable by said one or more cameras at each of said two or more exposure times.

2. The apparatus of claim 1, wherein the coded light is modulated with at least one modulation frequency and said property comprises the modulation frequency; the controller being configured to select the at least one modulation frequency, based on said information, to avoid frequency blind spots in said detection of the modulation caused by each of said two or more exposure times.

3. The apparatus of claim 1, wherein the coded light is modulated with a sequence of packets, and said at least one property comprises: a packet length of the packets, an inter-packet idle period between the packets, a ratio between the packet length and the inter-packet idle period, a total length of the packet length and inter-packet idle period, and/or a repetition rate of a message formed from the packets.

4. The apparatus of claim 1, wherein the one or more cameras are a plurality of cameras, and the two or more exposure times comprise exposure times of different ones of the cameras, the controller being configured to select the at least one property such that the modulation is detectable at each of the exposure times of the different cameras.

5. The apparatus of claim 4, wherein the one or more devices are a plurality of devices in the form of a plurality of user terminals, and the different cameras comprise cameras on different ones of the user terminals, the controller being configured to select the at least one property such that the modulation is detectable at the exposure times of the cameras on each of the different user terminals.

6. The apparatus of claim 4, wherein the one or more devices take the form of one or more user terminals, and the different cameras comprise cameras on a same one of the one or more user terminals.

7. The apparatus of claim 1, wherein the exposure times comprise different exposure times used by a same one of said one or more cameras at different times.

8. The apparatus of claim 2, wherein:
said at least one modulation frequency is a plurality of modulation frequencies, the modulation frequencies comprising multiple modulation frequencies of a same one of the one or more light sources, and/or the one or more light sources comprising a plurality of lights sources and the modulation frequencies comprising at least one modulation frequency of each of the light sources; and
the controller is configured to select the modulation frequencies to be distinct from one another and to each avoid the frequency blind spots caused by each of the two or more exposure times.

9. The apparatus of claim 1, wherein said apparatus is implemented on a bridge connecting between the one or more devices and the one or more light sources; and said interface is an external interface configured to receive the information relating to the exposure times from the one or more devices.

10. The apparatus of claim 1, wherein said apparatus is implemented in one of said one or more devices, said interface comprising an internal interface for receiving the information relating to at least one of the exposure times from said one of the one or more devices.

11. The apparatus of claim 10, wherein the one or more devices are a plurality of devices, the one or more cameras comprise a plurality of cameras on different ones of the devices, and the two or more exposure times comprise exposure times of different ones of the cameras on different ones of the devices; and said interface is an external interface configured to receive the information relating to at least one other of the exposure times from another of the user terminals.

12. The apparatus of claim 2, wherein the one or more devices are a plurality of devices, the one or more cameras comprise a plurality of cameras on different ones of the devices, and the two or more exposure times comprise exposure times of different ones of the cameras on different ones of the devices; and wherein the controller is configured to perform a negotiation comprising:
determining whether a value can be selected for the modulation frequency which avoids the frequency blind spots of each of the cameras on the different devices;
if so, selecting the value for the modulation frequency; and
if not, selecting a first value for the modulation frequency detectable by at least a first of the devices, requiring at least a second of the devices unable to detect the first value to wait until detection by the first device has finished, and then changing the modulation frequency to a second value detectable by the second device.

13. The apparatus of claim 2, wherein the one or more devices are a plurality of devices, the one or more cameras comprise a plurality of cameras on different ones of the devices, the two or more exposure times comprise exposure times of different ones of the cameras on different ones of the devices, and the one or more light sources comprise a plurality of lights sources, the plurality of light sources comprising a sub-group corresponding to a sub-sets of the devices; and
the controller is configured to restrict the determination of modulation frequency for the sub-group of light sources to determining at least one frequency detectable by the corresponding sub-set of devices.

14. The apparatus of claim 2, wherein the controller is configured to select the modulation frequency with:
a signal power resulting from the detection of the modulation that exceeds a disturbance threshold for each of the exposure times;
where the one or more cameras are a plurality of cameras, greater than a threshold difference in an apparent spatial frequency of the modulation as appearing over an image capture element of the different cameras; and/or
where the one or more cameras comprise a plurality of cameras, greater than a threshold difference in apparent temporal frequency of the modulation as captured by the different cameras.

15. The apparatus of claim 2, wherein the controller is configured to select the modulation frequency to be:
not an integer multiple of a frame rate of the one or more cameras; and/or
greater than a line rate of the camera with the highest line rate.

16. A computer program product for controlling one or more light sources to emit coded light which is modulated to embed a signal the computer program product downloadable from a communication network and/or stored on a computer-readable and/or executable medium, the computer program product comprising code embodied on a computer readable medium and configured so as when executed one or more processors to perform operations of:
receiving information relating to two or more exposure times of one or more cameras; on one or more devices, the one or more cameras being operable to detect the coded light based on the modulation; and
selecting the at least one property of the modulation, based on said information, such that the modulation is detectable at each of said two or more exposure times.
